(19) United States
(12) Patent Application Publication
(10) Pub. No.: US 2025/0251288 A1
(43) Pub. Date: Aug. 7, 2025

(54) CHIP TEMPERATURE MONITORING FOR SAFETY CRITICAL APPLICATIONS

(71) Applicant: Rivian IP Holdings, LLC, Irvine, CA (US)

(72) Inventors: Vasant Kumar EASWARAN, Frisco, TX (US); Srinivasa Sastry GUNTUR, Charlotte, NC (US)

(21) Appl. No.: 19/037,792

(22) Filed: Jan. 27, 2025

Related U.S. Application Data
(60) Provisional application No. 63/550,441, filed on Feb. 6, 2024.

(51) Int. Cl. G01K 3/00; G01K 3/14; G07C 5/08

(52) U.S. Cl. CPC G01K 3/005; G01K 3/14; G07C 5/0808

(57) ABSTRACT

Aspects of the disclosure relate to an integrated circuit that operates temperature or fault monitoring of one or more electronic components. An apparatus may include a first temperature sensor and a second temperature sensor at different locations. The first temperature sensor and the second temperature sensor may be positioned at different locations in order to have a comparative numeric relationship that is indicative of whether there is a fault in an electronic component during a baseline period.

### CROSS REFERENCE TO RELATED APPLICATION(S)

The present application claims the benefit of U.S. Provisional Application No. 63/550,441, entitled “NOVEL AND EFFICIENT APPROACH TO ON CHIP TEMPERATURE MONITORING FOR SAFETY CRITICAL APPLICATIONS”, filed Feb. 6, 2024, the entirety of which is incorporated herein for reference.

### INTRODUCTION

Automotive Safety Integrity Level (ASIL) is a risk classification system defined by the ISO 26262 standard for the functional safety of road vehicles. ASIL classifies hazards in one of four levels, denoted as A through D, with a fifth additional level for non-hazardous systems or components. ASIL D represents the highest level of risk, while ASIL A represents the lowest risk level.

The standard defines functional safety as “the absence of unreasonable risk due to hazards caused by malfunctioning behavior of electrical or electronic systems.” ASILs establish safety requirements-based on the probability and acceptability of hazard—for automotive components to be compliant with ISO 26262.

Systems that include vehicle brakes may require an ASIL-D grade—the highest rigor applied to safety assurance-because of the significant risks associated with their failure. ASIL-B examples are headlights and brake lights, while ASIL C may be for systems that include cruise control. Rear lights are example lights that may be classified with an ASIL-A grade.

Latent failures may be diagnosed by hardware built-in-self-test or with in-built redundancies to the monitor components (e.g., duplicated diodes and analog-to-digital converters (ADCs)).

Aspects of the subject technology can help to improve the overall cost, reliability, and efficiency of circuits or other electronic components.

### SUMMARY

The present description is generally directed to on-chip temperature monitoring methods, apparatuses, or systems that comply with functional safety of road vehicles. Latent failures may be diagnosed by hardware built-in-self-test or with in-built redundancies to the monitor components. The disclosed subject matter may use software to perform differential temperature diode temperature measurement checks at certain pre-defined use modes of an electronic component, which may include strategically placing temperature diodes in particular positions, to help achieve a threshold latent fault coverage.

In accordance with one or more aspects of the disclosure, one or more apparatuses, such as an integrated circuit, may have mechanisms for temperature or fault monitoring of one or more electronic components. The integrated circuit may include a first power domain, the first power domain may include a first temperature sensor, and a second power domain may include a second temperature sensor. The first temperature sensor and the second temperature sensor may be positioned to have a temperature difference that is indicative of whether there is a fault in an electronic component of the first power domain or the second power domain during a boot-up period. The boot up period may be defined by the start of the safety application. The electronic component may include the first temperature sensor or the second temperature sensor.

In accordance with one or more aspects of the disclosure, there may be one or more methods, systems, or apparatus for temperature or fault monitoring of one or more electronic components. In an example, a method may include receiving a first measured temperature of a first area associated with a trigger period; receiving a second measured temperature of a second area associated with the trigger period; determining a measured temperature difference between the first measured temperature and the second measured temperature; determining whether the measured temperature difference exceeds a reference threshold; and transmitting an indication that the measured temperature difference exceeds the reference threshold. The reference threshold may be based on a baseline temperature difference that may include a temperature difference between a first baseline temperature from the first area during a baseline period and a second baseline temperature from the second area during the baseline period.

In one or more implementations, there may be a transmission of an indication of a fault in a first component of the one or more electronic components based on the indication that the measured temperature difference exceeds the reference threshold. The first area and the second area may be indicative of a respective first power domain and a second power domain. The one or more electronic components may include a sensor. The one or more electronic components may include an integrated circuit. The baseline period may be a boot-up period for the one or more electronic components.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example integrated circuit that may be used to implement one or more features of temperature or fault monitoring of one or more electronic components.

FIG. 2 illustrates an example method for temperature or fault monitoring of one or more electronic components.

FIG. 3 illustrates an example sequence diagram associated with temperature or fault monitoring of one or more electronic components.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Automotive Safety Integrity Level (ASIL) rated system-on-chips (SoCs) may drive the need for monitors for dependent failure initiators like temperature to help detect single point failures in safety critical subsystems. This monitoring architecture is a safety mechanism designed to detect unexpected temperature rises or falls that may potentially have the subsystems malfunction when the temperature breaches the thresholds of the defined operating range. This helps provide the required diagnostic coverage for single point faults due to temperature variation.

In some implementations, to obtain a desired level of accuracy, temperature diodes may be used along with ADCs to read out temperatures at regular time intervals as defined by the fault tolerant time interval (FTTI) of the system, via digital controllers, of different parts of various safety critical subsystems that are spread across the SoC. In addition, checkers may be needed to verify whether the monitors themselves have latent failures. These monitors and checkers can be expensive for larger SoCs where there would be several such safety critical subsystems that need to be separately monitored. Monitors, such as diodes, may be duplicated for redundancy purposes. The use of redundant components may add cost and complexity.

To ensure that a safety system works correctly during a required period, the safety system may be required to detect permanent faults in the components that constitute the safety system itself that could potentially make the single point failures in the safety critical subsystems go latent. Latent failures may be diagnosed by hardware built-in-self-test or with in-built redundancies to the monitor components. Some implementations may incorporate duplicate sensors and corresponding connections of the sensors to ADC. These duplicate sensors may be implemented because each area in which the temperature is desired, there may be a primary temperature sensor and a secondary temperature sensor, in which the secondary temperature sensor may help verify the temperature of the primary temperature sensor or vice versa. This implementation may help verify that both temperature sensors are appropriately functional.

The disclosed subject matter may minimize the need for such duplicate sensors, which may help minimize cost or reduce complexity while still complying with safety coverage that may comply with standards, such as ASIL. The disclosed subject matter may include the performance of differential temperature diode temperature measurement checks at certain pre-defined use modes of the integrated circuit to help achieve high latent fault coverage.

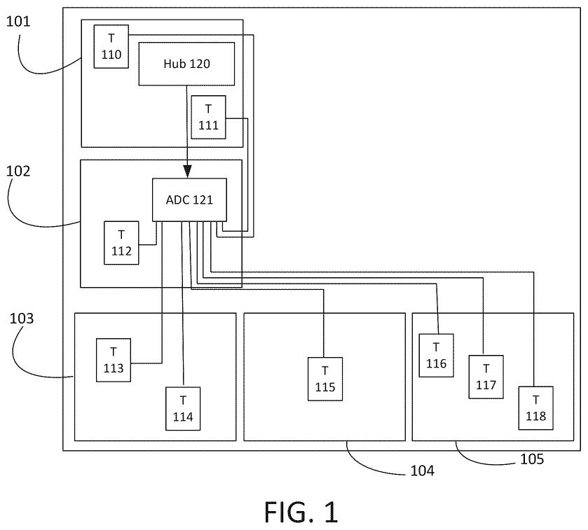

FIG. 1 illustrates an example integrated circuit 100 that may be used to implement one or more features of temperature or fault monitoring of one or more electronic components, as disclosed herein. Integrated circuit 100 may include multiple power domains (PDs), such as PD 101, PD 102, PD 103, PD 104, or PD 105. The PDs may include central processing unit (CPU) PDs or SOC PDs, among others. Each power domain may have one or more temperature sensors. As shown, PD 101 may include sensor 110, sensor 111, or sensor hub 120. PD 103 may include sensor 113 or sensor 114. PD 104 may include sensor 115. PD 105 may include sensor 116, sensor 117, or sensor 118. PD 102 may include sensor 112 and ADC 121. The disclosed sensors may have respective wired connections to ADC 121. ADC 121 may be communicatively connected with sensor hub 120.

With continued reference to FIG. 1, the disclosed safety system may use one or more expected comparative numeric relationships (such as temperature difference or ratio) associated with two or more sensors for a particular baseline period (e.g., during or soon after an initial boot-up sequence) to determine whether there is a fault.

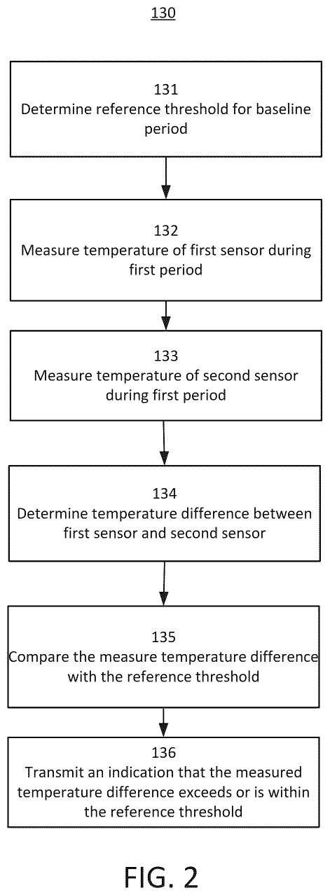

FIG. 2 illustrates an example method 130 for temperature or fault monitoring of one or more electronic components. At block 131, a reference threshold may be determined and stored for a group of sensors. The group of sensors may be two or more sensors that may be in the same area (e.g., power domain) or in different areas. For example, a first group of sensors may be sensor 110 and sensor 112 and a second group of sensors may be sensor 113 and sensor 115. Each group may have different reference thresholds for the baseline period.

In an example, the sensors may be measured and characterized offline in test setups, which may be the process in which the reference thresholds are defined. When the safety application is executed in a vehicle, the differences may be compared against the reference threshold that were determined offline. If there is a deviation then the sensors may be deemed to be incorrectly working.

The reference threshold may be based on a comparative numeric relationship (such as a temperature difference or a ratio) associated with two or more sensors for a baseline period. The baseline period may be associated with a use mode, such as boot-up sequence or system test during shutdown. The reference threshold may be a predetermined baseline and may be stored for future reference during a period that corresponds with the baseline period. In an example, the baseline period may be during or soon after an initial boot-up sequence in which each of the PDs are powered up, without running any application software. Test software may be run to measure each of the temperature sensors. It is contemplated that the reference threshold may include a single numeric value or a range of acceptable values (e.g., +/−2° F.) within a margin of error. A value outside the reference threshold may indicate a failure in one of the sensors.

Computing the differences may be particularly helpful because the ambience temperature in which the test is run may not be determined at that time and computing the difference may cancel out absolute ambient temperature value and retain only the location-specific temperature differences. The reference threshold values of the temperature differences may be determined during SoC characterization in the development time frame and pre-stored in non-volatile storage for the SoC.

At block 132, sensor 110 may measure temperature during a subsequent trigger period (e.g., a boot-up sequence). Sensor 110 may be located in PD 101. The measured temperature of sensor 110 may be sent to a CPU for processing. The trigger period may correspond with the stored baseline period.

At block 133, sensor 112 may measure temperature during a trigger period (e.g., a boot-up sequence). Sensor 112 may be located in PD 102. The measured temperature of sensor 112 may be sent to a CPU for processing. Sensor 110 and sensor 112 may be in the same grouping and there may be a corresponding reference threshold for the grouping.

At block 134, a measured temperature difference (or other comparative numeric relationship) may be determined between the first measured temperature of block 132 and the second measured temperature of block 133.

At block 135, the temperature difference of block 134 may be compared to the reference threshold. Based on the comparison, there may be a determination of whether the measured temperature difference of block 134 exceeds or is within the reference threshold of block 131.

At block 136, based on the determination of block 135, there may be an indication transmitted that the measured temperature difference exceeds or is within the reference threshold. In an example, an indication that the measured temperature difference exceeds the reference threshold may be used to determine that there is a fault in one or more sensors in the group, such as by using relative derivation from a baseline.

As disclosed, the reference threshold values may be compared against the measured values at a pre-defined resolution and detected anomalies may determine a permanent fault with the sensors involved. Through experimentation, it has been found that coverage of latent faults (e.g., failures in the sensors itself) may achieve ASIL-D level integrity.

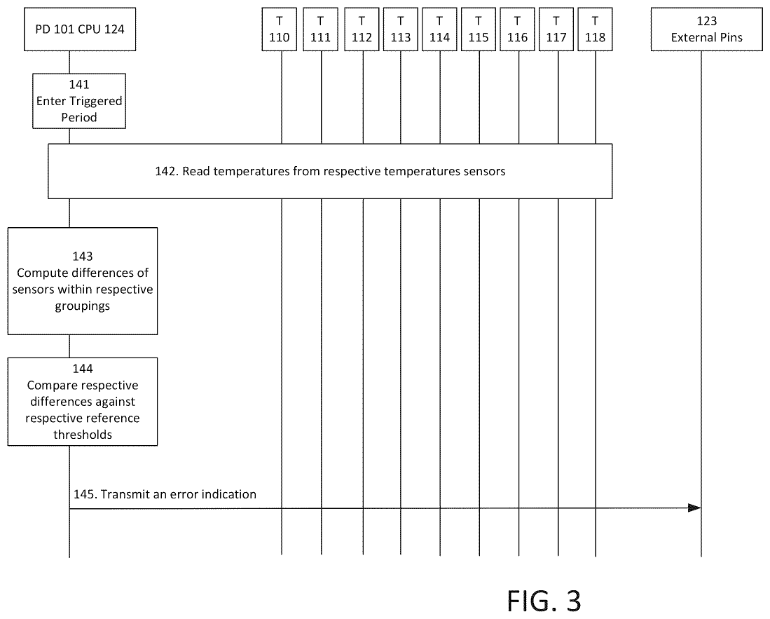

FIG. 3 illustrates an example sequence diagram associated with temperature or fault monitoring of one or more electronic components. At step 141, a CPU 124 of PD 101 may detect that a trigger period (e.g., boot-up sequence or the like) has occurred. In an example, as shown in Table 1, sensors may be assigned to different groups and each group may have one or more trigger periods and corresponding reference thresholds. At step 142, the CPU 124 of PD 101 may read the respective temperatures from each sensor, such as sensor 110, sensor 111, sensor 112, sensor 113, sensor 114, sensor 115, sensor 116, sensor 117, or sensor 118.

TABLE 1

| | | Trigger/Reference |
|---|---|---|
| | Sensors | Threshold |
| Group A | 110, 111 | Trigger A/RT A-1, |
| | | Trigger B/RT B-1 |
| Group B | 112, 113, 114 | Trigger A/RT A-2, |
| | | Trigger B/RT B-2, |
| | | Trigger C/RT C-1 |
| Group C | 115, 116 | Trigger A/RT A-3, |
| | | Trigger B/RT B-2 |
| Group D | 117, 118 | Trigger A/RT A-4, |
| | | Trigger B/RT B-3, |
| | | Trigger C/RT C-2 |

At step 143, the differences for each group may be computed. At step 144, the respective differences may be compared to the reference threshold. For example, if the trigger period is Trigger A, then Group A includes sensors 110 and 111, with a reference threshold of RT A-1. Group B, C, and D each include two or more sensors and reference thresholds for Trigger A as indicated in Table 1.

At step 145, based on the comparison of step 145 indicating an error, an error indication may be transmitted to external pins 123 for further actions. These further actions may be a display of the error on screen or restricting access to one or more features of a vehicle or other devices, such as disabling autonomous driving feature, or shutting down infotainment system, among other things.

The disclosed subject matter may be directed to on-chip temperature monitoring methods or systems that comply with Automotive Safety Integrity Level (ASIL). The disclosed subject matter may be used in or with automotive electronic components. Electronic components may be integrated into automobiles, such as an electric vehicle.

Methods, systems, and apparatuses, among other things, as described herein may provide temperature or fault monitoring of one or more electronic components. For example, a system may include a first power domain and a second power domain. The first power domain may include a first temperature sensor and the second power domain may include a second temperature sensor. The first temperature sensor and the second temperature sensor may be positioned to have a selected temperature difference or ratio, which may be non-zero, that is indicative of whether there is a fault (e.g., fault or no fault) in an electronic component of the first power domain or the second power domain during a triggered period, such as boot-up. The reference threshold disclosed herein may be considered the selected temperature difference or ratio. The reference threshold may be a range, which may account for an acceptable margin of error. The electronic component may include the first temperature sensor or the second temperature sensor. The first power domain may include an apparatus that transmits an error indication when comparing a measured temperature difference of the first temperature sensor or the second temperature sensor during a subsequent baseline period. The first power domain and the second power domain may be different. The system may further include a central processing unit; a sensor hub, the sensor hub communicatively connected with the central processing unit, wherein the central processing unit reads measured temperatures from the first temperature sensor or the second temperature sensor via sensor hub; and an analog-to-digital converter (ADC) communicatively connected with the first temperature sensor, the second temperature sensor, and the sensor hub. All combinations in this paragraph (including the removal or addition of steps or components) are contemplated in a manner that is consistent with the other portions of the detailed description.

The methods, systems, or apparatuses disclosed herein may be incorporated into electric vehicles or other devices. The methods, systems, or apparatuses disclosed herein may be incorporated into products, such as electronic control units (ECUs) to perform autonomous driving, infotainment, or vehicle dynamics/control In an example, a method may include receiving a first measured temperature of a first area associated with a trigger period; receiving a second measured temperature of a second area associated with the trigger period; determining a measured temperature difference between the first measured temperature and the second measured temperature; determining whether the measured temperature difference exceeds a reference threshold; and transmitting an indication that the measured temperature difference exceeds the reference threshold. The reference threshold may be based on a baseline temperature difference that includes a temperature difference between a first baseline temperature from the first area during a baseline period and a second baseline temperature from the second area during the baseline period. The first area and the second area may be within the same power domain. All combinations in this paragraph and the previous paragraphs (including the removal or addition of steps or components) are contemplated in a manner that is consistent with the other portions of the detailed description.

The method may include transmitting an indication of a fault in a first component of the one or more electronic components based on the indication that the measured temperature difference exceeds the reference threshold. The first area or the second area may be indicative of a respective first power domain or a second power domain. The first power domain and the second power domain may be the same or different. The one or more electronic components may include one or more sensors. The one or more electronic components may include an integrated circuit. The trigger period may be a boot-up period for the one or more electronic components. The trigger period may be a boot-up period, without running application software. The reference threshold values may be compared against the measured values at a pre-defined resolution and any anomalies may determine a permanent fault with the sensors involved. All combinations in this paragraph and the previous paragraphs (including the removal or addition of steps or components) are contemplated in a manner that is consistent with the other portions of the detailed description.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A method for temperature or fault monitoring of one or more electronic components, the method comprising:
receiving a first measured temperature of a first area associated with a trigger period;
receiving a second measured temperature of a second area associated with the trigger period;
determining a measured temperature difference between the first measured temperature and the second measured temperature;
determining whether the measured temperature difference exceeds a reference threshold, wherein the reference threshold is based on a baseline temperature difference that comprises a temperature difference between a first baseline temperature from the first area during a baseline period and a second baseline temperature from the second area during the baseline period; and
transmitting an indication that the measured temperature difference exceeds the reference threshold.

2. The method of claim 1, further comprising transmitting an indication of a fault in a first component of the one or more electronic components based on the indication that the measured temperature difference exceeds the reference threshold.

3. The method of claim 1, wherein the first area is indicative of a first power domain and the second area is indicative of a second power domain, wherein the first power domain and the second power domain are different.

4. The method of claim 1, wherein the one or more electronic components comprise a sensor.

5. The method of claim 1, wherein the one or more electronic components comprise an integrated circuit.

6. The method of claim 1, wherein the trigger period is a boot-up period for the one or more electronic components.

7. The method of claim 1, wherein the one or more electronic components is integrated into an electric vehicle.

8. An integrated circuit comprising:
a first power domain, the first power domain comprising a first temperature sensor; and
a second power domain, the second power domain comprising a second temperature sensor, wherein the first temperature sensor and the second temperature sensor are positioned to have a temperature difference that is indicative of whether there is a fault in an electronic component of the first power domain or the second power domain during a boot-up period.

9. The integrated circuit of claim 8, wherein the electronic component comprises the first temperature sensor or the second temperature sensor.

10. The integrated circuit of claim 8, wherein the first power domain and the second power domain are different.

11. The integrated circuit of claim 8, wherein the integrated circuit is integrated into a component of an electric vehicle.

12. An integrated circuit comprising:
a first temperature sensor; and
a second temperature sensor, wherein the first temperature sensor and the second temperature sensor are positioned to have a comparative numeric relationship that is indicative of whether there is a fault in an electronic component during a baseline period.

13. The integrated circuit of claim 12, wherein the baseline period comprises a boot-up period of one or more power domains of the integrated circuit.

14. The integrated circuit of claim 12, wherein the comparative numeric relationship comprises a difference of the first temperature sensor and the second temperature sensor.

15. The integrated circuit of claim 12, wherein the comparative numeric relationship comprises a ratio of the first temperature sensor and the second temperature sensor.

16. The integrated circuit of claim 12, wherein the electronic component comprises the first temperature sensor or the second temperature sensor.

17. The integrated circuit of claim 12, wherein the first temperature sensor and the second temperature sensor are located in a respective first area and a second area of a first power domain.

18. The integrated circuit of claim 12, wherein the first temperature sensor is located in a first power domain and the second temperature sensor is located in a second power domain, wherein the first power domain and the second power domain are different.

19. The integrated circuit of claim 12, further comprising:
a central processing unit;
a sensor hub, the sensor hub communicatively connected with the central processing unit, wherein the central processing unit reads measured temperatures from the first temperature sensor or the second temperature sensor via sensor hub; and
an analog-to-digital converter (ADC) communicatively connected with the first temperature sensor, the second temperature sensor, and the sensor hub.

20. The integrated circuit of claim 12, wherein the integrated circuit is a component of an electronic control unit (ECU) that is used to implement safety critical function within an electric vehicle.
